(19) United States
(12) Patent Application Publication
(10) Pub. No.: US 2010/0046720 A1
(43) Pub. Date: Feb. 25, 2010

(54) Point-in-poly routing for voice over internet protocol (VoIP) emergency calls with embedded geographic location information

(76) Inventor: Gerhard Geldenbott, Seattle, WA (US)

Correspondence Address: MANELLI DENISON & SELTER PLLC, 2000 M Street, N.W., 7th Floor, Washington, DC, 20036-3307, US

(21) Appl. No.: 12/230,901

(22) Filed: Sep. 8, 2008

Related U.S. Application Data
(60) Provisional application No. 61/136,268, filed on Aug. 22, 2008.

(51) Int. Cl. H04M 11/04

(52) U.S. Cl. 379/45

(57) ABSTRACT

The correct PSAP that can service an emergency call originating from a VoIP terminal with the caller's geographic information embedded in the call signaling is determined. A latitude and longitude is extracted from geographic information that is embedded in the call signaling. In some cases only the civic address is available. Then a database is accessed to associate spatial polygons that represent the geographic boundaries of the 6000+ PSAPs in the nation to given latitude and longitude information extracted from the emergency call. The combination of these two important features together result in an accurate and precise “just-in-time” PSAP selection for the caller.

This application claims priority from U.S. Provisional Application No. 61/136,268, entitled “Point-In-Poly Routing For Voice Over Internet Protocol (VoIP) Emergency Calls With Embedded Geographic Location Information”, to Geldenbott, filed Aug. 22, 2008, the entirety of which is explicitly incorporated herein by reference.

### BACKGROUND OF THE INVENTION

1. Field of the Invention

This invention relates generally to telecommunications and long distance carriers, Internet Service Providers (ISPs), and information content delivery services/providers in general. More particularly, it relates to emergency call systems (e.g., E9-1-1) including wireless and Internet Protocol (IP) based Voice Over Internet Protocol (VoIP) emergency call systems.

2. Background of Related Art

9-1-1 is a phone number widely recognized in North America as an emergency phone number that is used to contact emergency dispatch personnel. Enhanced 9-1-1 (E9-1-1) is defined by an emergency call being selectively routed to an appropriate PSAP, based on a special identifier (P-ANI, or “Pseudo Automatic Number Identifier”, also referred to as “ESxK”), and includes the transmission of callback number and location information when 9-1-1 is used. E9-1-1 may be implemented for landline, cellular or VoIP networks. Regardless of the network type, a 9-1-1 service becomes E-9-1-1 when automatic number identification and automatic location information related to the call is provided to the 9-1-1 operator at the PSAP.

A Public-Safety Answering Point (PSAP) is a dispatch office that receives 9-1-1 calls from the public. A PSAP may be a local, fire or police department, an ambulance service or a regional office covering all services. As used herein, the term “PSAP” refers to either a PSAP, or to an Emergency Call Center (ECC), a VoIP term.

Distributed emergency call systems in telecommunications are in general very complex computing systems. Emergency calls that originate from a VoIP network use well proven routing paradigms already used for cellular 911 calls, or for traditional landline 911 calls. These paradigms usually work well, because VoIP customers can usually be grouped into two categories, a mobile VoIP caller that resembles a cellular user, and a stationary VoIP user resembling landline usage.

Traditional landline systems use pre-provisioned subscriber addresses, where the landline automatic location identification (ALI) provisioning process (i.e., SOI) insures a match to a master street address guide (MSAG) record, which contains an emergency service number (ESN) used to route emergency calls to a PSAP.

Some conventional cellular systems use separate triangulation technologies to find a latitude & longitude of an emergency caller. These systems then use a geographic information system (GIS) system to query for the PSAP polygon that contains this location. But even though it's very possible that these queried PSAP polygons can lead to a different (i.e., wrong), neighboring PSAP than an equivalent address provisioned in a landline ALI, this discrepancy is conventionally accepted by PSAPs because the location itself is likely to be imprecise due to measurement errors—sometimes the location is off by hundreds of feet.

Conventional VoIP systems use proprietary technologies, usually based on GIS polygons, or based on pre-provisioning of the caller in the traditional landline ALI long before the need for an emergency call. But this pre-provisioning in reality takes at least a few hours, and sometimes as long as a few days.

Traditional landline paradigms provide the most accurate location, but require the caller's address to be pre-provisioned into a landline automatic location identifier (ALI). This pre-provisioning (often referred to as service order interface (SOI) loading) usually takes a few days between the caller notifying their service provider of their address change, and this change being reflected in the landline ALI. But during this window a 911 call might be made, and if so it would be routed using the “old” data still in the landline ALI. Even the fastest possible conventional landline ALI provisioning takes at least several hours.

The conventional systems are disadvantageous because they are unable to handle the embedded geographic location to precisely route the caller to the correct PSAP using the “just-in-time” paradigm.

### SUMMARY OF THE INVENTION

In accordance with the principles of the present invention, a responsible public service access point (PSAP) is associated with an emergency caller, comprising extracting a latitude and longitude from geographic information that is embedded in call signaling, and initiating access to a geodatabase associating a spatial polygon representing a respective PSAP service region with a given latitude and longitude. In this way, a precise just-in-time PSAP selection may be provided for a given caller.

### BRIEF DESCRIPTION OF THE DRAWINGS

Features and advantages of the present invention will become apparent to those skilled in the art from the following description with reference to the drawings:

FIG. 1 shows an exemplary Geographic Information System (GIS) “geodatabase” Polygon Map, in accordance with the principles of the present invention.

FIG. 2 shows a sample Table GIS Polygon to PSAP data store.

### DETAILED DESCRIPTION OF ILLUSTRATIVE EMBODIMENTS

The present invention provides the accuracy of landline ALI-based provisioning, while using Cellular 911's and VoIP 911 just-in-time paradigm for routing calls. The present invention is particularly useful for VoIP Subscribers using user agents (UA) that embed the geographic location of the calling source in the 911 signaling protocol (typically the SIP protocol).

According to the principles of the present invention, a caller's location is extracted from call signaling supplied with an incoming emergency call. The extracted call information is used to lookup an appropriate PSAP polygon in an appropriate nationwide database. If the address is available, the MSAG validated address is looked up from the extracted call information using a nationwide database. If the MSAG validated address is available, then precise data about the caller may be delivered to the appropriate PSAP.

The embedded geographic location can be either a civic address, or latitude and longitude, or both.

The present invention presents a unique solution to route an emergency call of this nature to the correct PSAP (Public-safety answering point) in contrast to traditional landline systems, traditional cellular systems, and conventional VoIP systems.

The described technology provides a way of determining the correct PSAP that can service an emergency call originating from a VoIP terminal with the caller's geographic information embedded in the call signaling.

An first important feature of the present invention is to extract a latitude and longitude from the geographic information that is embedded in the call signaling. In many cases, the calling device includes the latitude and longitude of the calling device. In some cases only the civic address is available, however, a civic address can usually be associated with fairly accurate values for the longitude and latitude.

A second important feature is the usage of a commercial GIS “geodatabase” that acts as the database access engine to spatial data. The database is programmed with spatial polygons that represent the geographic boundaries of the 6000+ PSAPs in the nation. Given the latitude and longitude and the geodatabase, the caller can be readily associated with the correct PSAP by a simple database lookup.

The combination of these two important features together result in an accurate and precise “just-in-time” PSAP selection for the caller in accordance with the principles of the present invention.

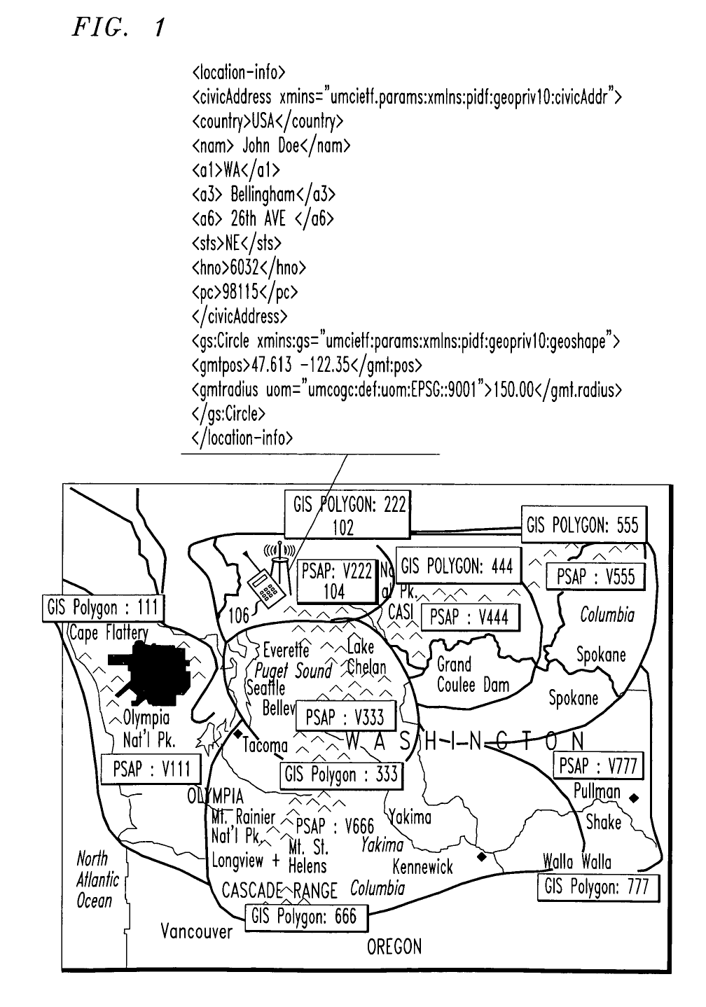

FIG. 1 shows an exemplary Geographic Information System (GIS) “geodatabase” Polygon Map, in accordance with the principles of the present invention.

In particular, the example of FIG. 1 shows just one state 100 within the nation (Washington State) with seven sample GIS polygons. The invention covers the entire nation. For simplicity only one state is shown in FIG. 1.

As shown in FIG. 1, a sample caller is shown to be within GIS Polygon 222 102. A first feature of the present invention (referred to as Key #1) is to extract a latitude and longitude from the geographic information that is embedded in the call signaling. In this example the calling device includes the latitude/longitude and civic address in the call signaling in standardized XML format 100. In other cases only the civic address may be available, however, a civic address can usually be associated with fairly accurate values for the longitude and latitude.

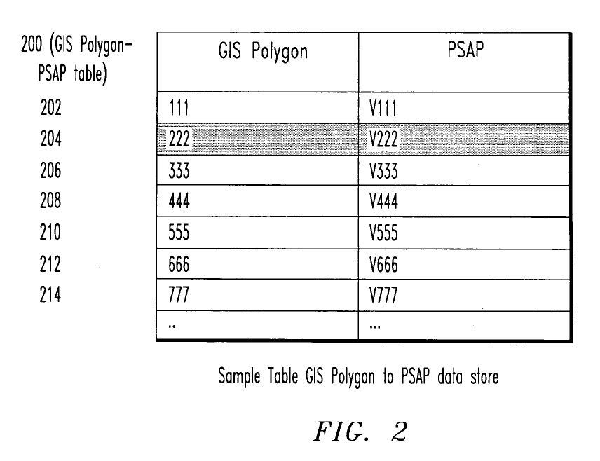

FIG. 2 shows a sample Table GIS Polygon to PSAP data store, in accordance with the principles of the present invention.

In FIG. 2, a sample Table GIS Polygon to PSAP data store presents the second feature of the present invention (referred to as Key #2 below).

In particular, as shown in FIG. 2, the retrieved latitude and longitude is fed into a commercial GIS “geodatabase” that acts as the database access engine to spatial data. The database 200 is programmed with spatial polygons that represent the geographic boundaries of the 6000+ PSAPs in the nation. Given the latitude and longitude and the geodatabase, the caller can be readily associated with the correct PSAP by a simple database lookup. In this example the GIS “geodatabase” lookup results in GIS Polygon 222. Using the “GIS Polygon to PSAP data store” with the GIS Polygon as the input yields PSAP V222 204 as the PSAP serving the caller. With that information the call can be redirected to the correct PASP.

Accordingly, combining the two important features, Key #1 (the caller's location) and Key #2 (using a commercial GIS “geodatabase” to find the polygon that is associated with the PSAP servicing the caller) results in an accurate and precise “just-in-time” PASP selection for the caller in a new and inventive manner that covers the entire nation.

While the invention has been described with reference to the exemplary embodiments thereof, those skilled in the art will be able to make various modifications to the described embodiments of the invention without departing from the true spirit and scope of the invention.

What is claimed is:

1. A method of determining a correct public service access point (PSAP) for an emergency call, comprising:
extracting a latitude and longitude from geographic information that is embedded in call signaling; and
initiating access to a geodatabase associating a spatial polygon representing a respective PSAP service region with a given latitude and longitude;
wherein a precise just-in-time PSAP selection may be provided for a given caller.

2. The method of determining a correct public service access point (PSAP) for an emergency call according to claim 1, wherein said extracting comprises:
extracting said latitude and longitude from a civic address.

3. The method of determining a correct public service access point (PSAP) for an emergency call according to claim 1, wherein:
said emergency call originates from a voice over internet protocol (VoIP) terminal.

4. A method of determining a correct public service access point (PSAP) for an emergency call, comprising:
extracting a latitude and longitude from geographic information that is embedded in call signaling; and
initiating access to a master street address guide (MSAG) geodatabase associating a street address represented by a respective PSAP service region with a given latitude and longitude;
wherein a precise just-in-time PSAP selection may be provided for a given caller.

5. The method of determining a correct public service access point (PSAP) for an emergency call according to claim 4, wherein said extracting comprises:
extracting said latitude and longitude from a civic address.

6. The method of determining a correct public service access point (PSAP) for an emergency call according to claim 4, wherein:
said emergency call originates from a voice over internet protocol (VoIP) terminal.
